(19) United States
(12) Patent Application Publication
(10) Pub. No.: US 2007/0162417 A1
(43) Pub. Date: Jul. 12, 2007

(54) System and method for selective access to restricted electronic documents

(75) Inventors: Costin Cozianu, Torrence, CA (US); George Koppich, Palos Verde Estates, CA (US)

Correspondence Address: TUCKER, ELLIS & WEST LLP, 1150 HUNTINGTON BUILDING, 925 EUCLID AVENUE, CLEVELAND, OH, 44115-1414, US

(73) Assignees: Kabushiki Kaisha Toshiba; Toshiba Tec Kabushiki Kaisha

(21) Appl. No.: 11/328,934

(22) Filed: Jan. 10, 2006

(51) Int. Cl. G06F 17/30

(52) U.S. Cl. 707/1

(57) ABSTRACT

A system and method for selective sharing of restricted electronic documents. A requesting client generates query data representing a search for one or more documents stored on a document management system. The query data is then analyzed by an indexing engine and a repository containing a plurality of documents is searched. Documents meeting the query data are located and a list of the documents is returned to the requesting client. The client selects a document from the list and a determination is made whether the document is a restricted access document. When the document is restricted in access, the document management system forwards a request from the requesting client to a custodian client associated with the restricted document. The custodian client is then able to selectively allow access to the document, without the requesting client learning the identity of the custodian or the contents of the restricted document.

### BACKGROUND OF THE INVENTION

This invention is directed to a system and method for selective sharing of restricted electronic documents. In particular, the present invention is directed to a document management system and method which provides automated indexing of electronic documents and allows for selective or customized sharing of restricted or confidential electronic documents.

Document management systems allow users to create centralized repositories, or libraries, containing all of the data they generate, such as information stored in documents, spreadsheets, text files, electronic mail, multimedia, etc. Powerful search and retrieval tools make this information easily available for use and collaboration across the entire enterprise. In certain instances, a user requires that a certain document or other electronic file not be widely disseminated or have restricted access. The selected document or file will be marked as private or restricted access and will be not indexed or searchable, other than by those users which are allowed to access to the document. Access to such documents may be modified, but that requires the user that created the document to manually access the document and modify the access criteria.

In addition, the circumstances which required a document to have restricted access have changed, the information contained in the document may be made available for use by others. For example, a project team will create documents during the course of the project relating to the team's work. Access to these documents is often restricted to the project team. If another project team is working on a similar project or encountering similar development issues, the members of the second project may desire to review the information collected by the first project team. In order to allow the members of the second project team to access the documents, the access requirements for each relevant document will have to modified, which may be very time consuming. Further, every time there is a change in the staffing of the project team, the access requirements will have to be modified for every change. Therefore, there is a need for a system and method for selective sharing of restricted electronic documents.

The subject invention overcomes the above-noted problems and provides a system and method provides automated indexing of electronic documents and allows for selective or customized sharing of restricted or confidential electronic documents.

### SUMMARY OF THE INVENTION

In accordance with the present invention, there is provided a system and method for selective sharing of restricted electronic documents.

Further, in accordance with the present invention, there is provided a system and method for automated indexing of electronic documents and allows for selective or customized sharing of restricted or confidential electronic documents.

Still further, in accordance with the present invention, there is provided a system and method for sharing information among various users and groups associated with a document management system.

Still further, in accordance with the present invention, there is provided a system for selective sharing of restricted electronic documents. The system includes means adapted for receiving query data representative of a query relative to a plurality of electronic documents stored in an associated memory, wherein each of the electronic documents being associated with identifier data representative of at least one custodian thereof. The system also includes means adapted for receiving identification data corresponding to the received query data. The identification data is representative of an identity of a source of a query associated therewith. The system also comprises comparison means adapted for comparing the query data to document data associated with the plurality of electronic documents. The system further comprises means adapted for generating list data representative of each document responsive to the query in accordance with an output of the comparison means, which list data includes data representative of at least one restricted document and notification means adapted for generating a notification signal to at least one custodian corresponding to each restricted document represented in the list data.

Still further, in accordance with the present invention, there is provided a method for selective sharing of restricted electronic documents. The method comprises receiving query data representative of a query relative to a plurality of electronic documents stored in an associated memory, wherein each of the electronic documents being associated with identifier data representative of at least one custodian thereof. The method also includes receiving identification data corresponding to the received the query data, wherein the identification data is representative of an identity of a source of a query associated therewith. The method further comprises the steps of comparing the query data to document data associated with the plurality of electronic documents, generating list data representative of each document responsive to the query in accordance with an output of the comparison means, which list data includes data representative of at least one restricted document, and generating a notification signal to at least one custodian corresponding to each restricted document represented in the list data.

Still other objects and aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram of the system according to the present invention;

FIG. 2 is a flowchart illustrating a method for selective sharing of restricted electronic documents in accordance with the present invention

FIG. 3 is a flowchart illustrating a method for selective sharing of restricted electronic documents in accordance with the present invention; and

FIG. 4 is a flowchart illustrating a method for selective sharing of restricted electronic documents in accordance with the present invention.

### DETAILED DESCRIPTION OF THE PREFERRED EMBODIMENT

This invention is directed to a system and method for selective sharing of restricted electronic documents. In particular, this invention is directed to a system and method for automated indexing of electronic documents and allows for selective or customized sharing of restricted or confidential electronic documents. More particularly, this invention is directed to a system and method for sharing information among various users and groups associated with a document management system.

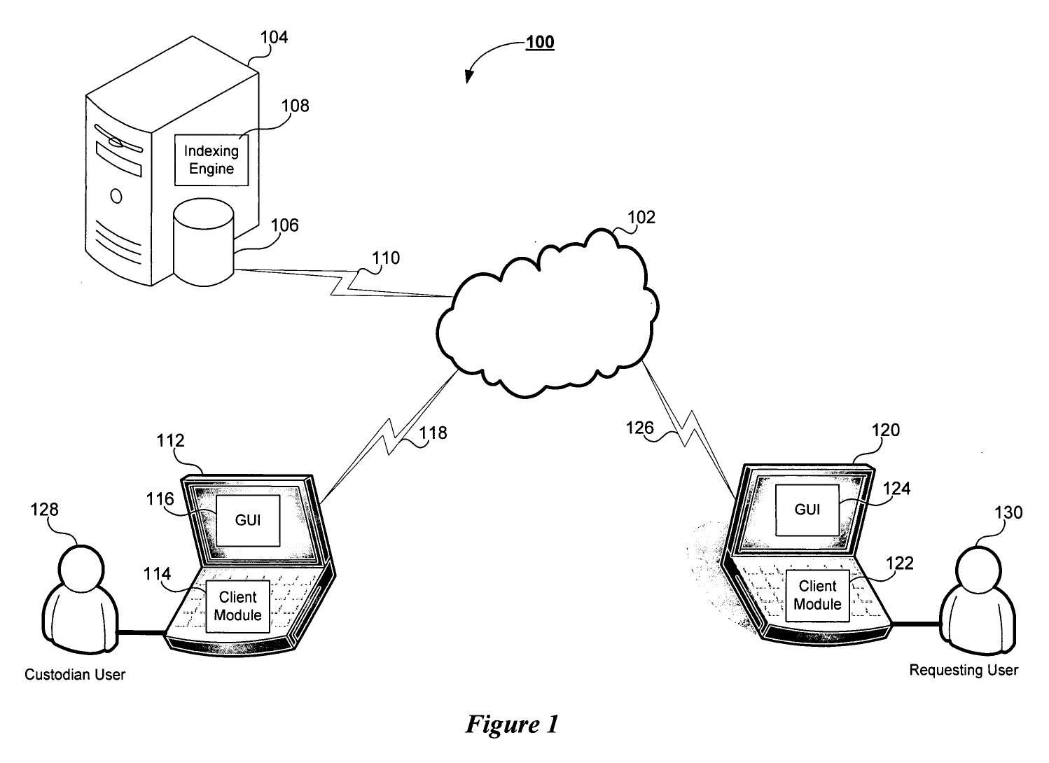

Turning now to FIG. 1, there is shown a block diagram illustrating a system 100 in accordance with the present invention. The system 100 is used herein for example purposes only and the instant invention is capable of implementation in a variety of computing environments, other than the network environment illustrated in FIG. 1. The system 100 is implemented using a distributed computing environment, shown as the computer network 102. It will be appreciated by those skilled it the art that the computer network 102 is any computer network known in the art capable of enabling communications between two or more electronic devices. As will be understood by those skilled in the art, the subject invention is capable of implementation over any suitable computer network, including, for example and without limitation, the Internet, an Ethernet-based network, a Token Ring based network, an intranet, a personal area` network, a local area network, a wide area network, wireless, or any combination thereof.

The system 100 further includes a document management system, illustrated in FIG. 1 as including the document management server 104, document repository 106 and indexing engine 108. Those skilled in the art will appreciate that a document management system, as used herein, is suitably adapted to control the creation, storage, access, and disposition of electronic documents. For purposes of explanation, the document management system is any hardware, software, or suitable combination thereof facilitating the management of a plurality of electronic documents. As used hereinafter, the document management system is used interchangeably with the document management server 104, on which the document management system operates in conjunction with the repository 106 and the indexing engine 108. Those skilled in the art will understand that the server 104 is any hardware, software, or combination thereof suitably adapted to provide access and control to applications, data, resources, and the like, to users via the computer network 102. Although illustrated in FIG. 1 as a server, the document management server 104 is capable of implementation on any personal electronic device capable of providing the document management services described hereinafter. The skilled artisan will appreciate that the server 104 is suitably adapted to implement restricted access to the services offered thereon. Preferably, the server 104 is in communication via a suitable communications link 110. Those of ordinary skill in the art will appreciate that the communications link 110 is any communications channel known in the art capable of allowing the exchange of voice, image, video, or text data. Suitable communications links include, for example and without limitation, Bluetooth, WiMax, infrared, optical, or any suitable wireless data transmission system, or wired communications known in the art.

The document repository 106 component is communicatively coupled to the server 104 and provides storage for the electronic documents associated with the document management system. As will be appreciated by those skilled in the art, the document repository 106 is any suitable mass storage device known in the art capable of storing one or more electronic files. The skilled artisan will understand that the document repository 106 is capable of implementation as any mass storage device known in the art, including for example and without limitation, hard disk drives, optical storage devices, flash memory, electromagnetic storage devices, and any other non-volatile memory device known in the art. The document management system further includes an indexing engine 108 suitably adapted to facilitate the ordered storage of electronic documents on the repository 106, as well as the searching of the contents thereof. As will be appreciated by those skilled in the art, the indexing engine 108 is any software, hardware, or any combination thereof suitably capable of providing searching and indexing services to a requesting client.

The system 100 illustrated in FIG. 1 includes a custodian client device 112, depicted as a notebook computer. The skilled artisan will appreciate that the illustration of the custodian client device 112 as a notebook computer is for example purposes only, and the custodian client device 112 is capable of being implemented as any personal electronic device capable of generating electronic document data and communicating such data to the document management server 104. The custodian client device 112 includes a client module 114 suitably adapted to monitor electronic documents stored and generated locally, as well as remotely on the repository 106, and to facilitate the administration of accessibility to such electronic documents originating from the custodian client device 112. Preferably, the client module 114 is any hardware, software, or suitable combination thereof, implemented internally to the client device 112. It will be appreciated by those skilled in the art that the client module 114 is capable of implementation as an external device containing suitable software thereon, which is communicatively coupled to the custodian client device 112 via any means known in the art, including, for example and without limitation, PCI, USB, Firewire, PCMCIA, PCIe, and the like. In the preferred embodiment, the client module 114 is suitably adapted to facilitate the selection by an associated user of restrictions of access to an electronic document generated by the custodian client device 112. In such an embodiment, the client module 114 is advantageously capable of receiving notification of a request for access to such a document received from the document management server 104 and granting access to such a document upon receipt of a request from a requesting user.

The client device 112 further includes a graphical user interface, or GUI, 116, advantageously generated via the client module 114 and suitably adapted to facilitate user-interaction with respect to the generation and storage of electronic documents on the document management server 104. Preferably, the client device 112 is communicatively coupled to the computer network 102 via a suitable communications link 118. As will be understood by those skilled in the art, the communications link 118 is any communications channel known in the art, including, for example and without limitation, infrared, optical, WiMax, 802.11(x), Bluetooth, or any suitable wireless data transmission system or wired communications known in the art.

The system 100 further includes a requesting client device 120 depicted as a notebook computer. The skilled artisan will appreciate that the requesting client device 120 is illustrated as a notebook computer for example purposes only, and the requesting client device 120 is capable implementation as any personal electronic device capable of viewing electronic document data and communicating with the document management server 104 via the computer network 102. The requesting client device 120 includes a client module 122 suitably adapted to receive input from an associated user regarding the content of a search for one or more electronic documents stored on the repository 106 of the document management server 104. Preferably, the client module 122 communicates a search request to the indexing engine 108, which performs a search of the repository 106 to retrieve the document or documents matching the search parameters selected by the user. It will be appreciated by those skilled in the art that the client module 114 and the client module 122 are the same software, hardware, or combination thereof, but are performing different functions based on the user associated therewith. Thus, the author of the document is a custodian and the client module 114 functions accordingly, whereas the client module 122 is associated with the requesting user and therefore functions accordingly. The client module 122 is capable of implementation as an external device containing suitable software thereon, which is communicatively coupled to the requesting client device 120 via any means known in the art, including, for example and without limitation, PCI, USB, Firewire, PCMCIA, PCIe, and the like.

The client device 122 further includes a graphical user interface, or GUI, 124, advantageously generated via the client module 122 and suitably adapted to facilitate user-interaction with respect to the generation and storage of electronic documents on the document management server 104. Preferably, the client device 120 is communicatively coupled to the computer network 102 via a suitable communications link 126. As will be understood by those skilled in the art, the communications link 126 is any communications channel known in the art, including, for example and without limitation, infrared, optical, WiMax, 802.11a, 802.11b, 802.11g, 802.11(x), Bluetooth, or any suitable wireless data transmission system or wired communications known in the art.

In operation, the associated custodian user 128, via the custodian client device 112, generates an electronic document via any suitable means, such as, for example and without limitation a word processing application. In the preferred embodiment, the client module 114 is an application running in the background of the custodian device 112. The client module 114 monitors document processing operations on the custodian device 112 and detects each new document creation and update, e.g., document save, and compares the document type/template against specified policy criteria for indexing and privacy settings. The client module 114 then sends those documents meeting the criteria and/or settings to the indexing engine 108 of the document processing server 104 for indexing and storage on the repository 106. Suitable policy criteria includes, for example and without limitation, documents relating to a specific matter, originating in a specific application, documents addressed to a specific individual(s), and the like. In accordance with one aspect of the subject invention, each document subject to access restriction is advantageously encrypted, via any suitable means, so as to prevent unauthorized access to the document absent consent of the custodian user 128. In accordance with another aspect of the present invention all documents submitted to the document management server 104 are encrypted.

The requesting user 130, via the requesting client device 120, initiates the client module 122, which activates a graphical user interface 124 displayed to the associated requesting user 130 of the client device 120. The user then inputs search criteria via the graphical user interface 124 using any means known in the art. The client module 122 gathers this search criterion to generate a search request, which is then transmitted to the indexing engine 108 of the document processing server 104 via the computer network 102. Preferably, the client module 122 also transmits identification data representing the identity of the requesting user 130 associated with the search request so as to enable the document management server 104 to determine the access rights associated therewith. The requesting user 130, via the client device 120, then receives a list of electronic documents stored within the repository 106 and meeting the search parameters. This list is advantageously displayed to the associated user via the graphical user interface 124. For those documents which have no access restrictions in place, the requesting device 120 is able to retrieve the documents from the document repository 106 for further review or action.

When a search initiated by a requesting user 130 returns a document for which the custodian user 128 is custodian and which includes access restrictions, the requesting user 130 is denied further information about the author, other than the existence of a document that matches the search criteria. The requesting user 130 is then capable of requesting the document, via the requesting device 120, from the custodian user 128 through the document management server 104, again without gaining the identity of the custodian user 128. Preferably, a notification is sent to the client module 114 of the custodian device 112 identifying the requesting user 130 and the document associated with the request. It is to be appreciated by those skilled in the art that the notification is preferably comprised of an electronic message, which appears in an electronic mail program resident on the custodian device 112. However other means of receiving and displaying document requests are equally capable of being implemented in accordance with the present invention. For example, the client module 114, upon receipt of the request, is capable of instructing the graphical user interface 116 to display the message, requesting device 120 identification, and to facilitate the response to the request. More preferably, the notification includes identification data representative of the specific user 130 associated with the search request which returned the access restricted document. In accordance with one aspect of the present invention, a custodian user 128, via custodian device 112, is automatically notified by the server 104 when a restricted access document is returned in a search. In the preferred embodiment, the notification is generated when the requesting user, via device 120, transmits a request to the custodian user 128 through the server 104 for access.

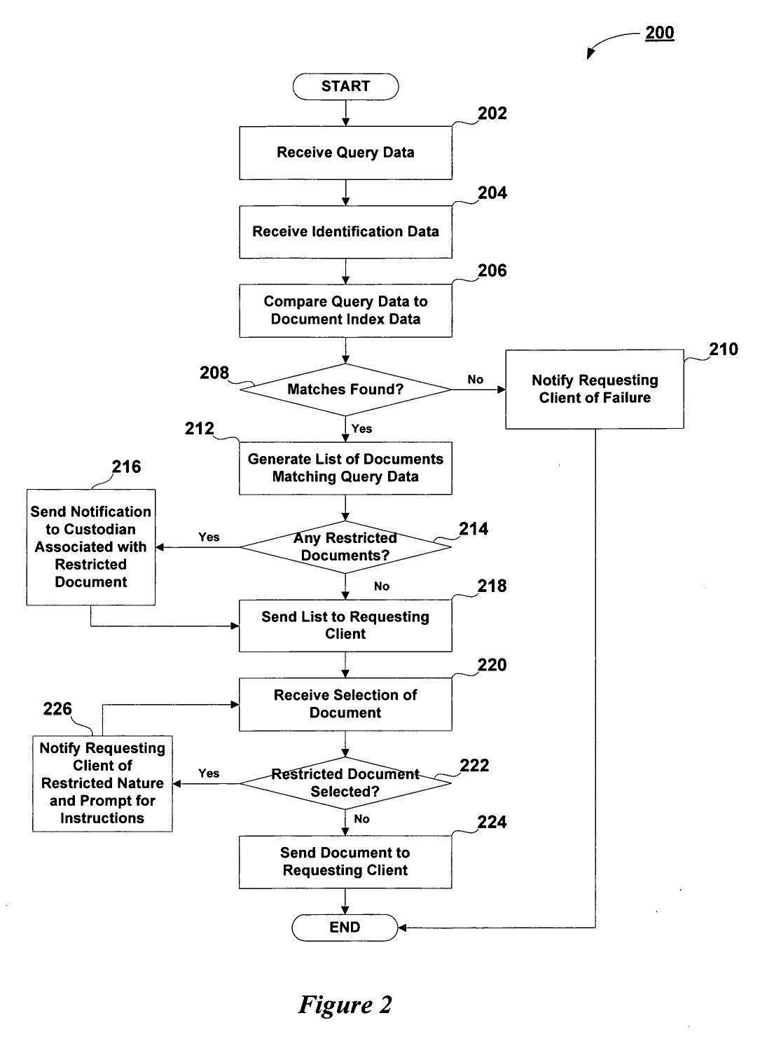

The custodian user 128, via custodian device 112, is then able to select whether or not to allow the requesting user 130 access to the restricted document. Denial of the request is accomplished via no response, or a response indicating the rationale for the refusal, as desired by the custodian user 128. In the preferred embodiment, all communications regarding access to restricted documents is accomplished through the document management server 104. The custodian user 128 at custodian device 112, via the client module 114, is also able to transmit a command to the document management server 104 to grant access to the restricted document. Alternatively, as the custodian user 128 has the identification information regarding the requesting user, the custodian user 128 is able to directly contact, e.g., telephone, electronic mail, text messaging, and the like, the requesting user 130 to determine what content is sought. The custodian user 128, via the custodian device 112, then generates a second document containing only that data sought, thereby maintaining the privacy of the remainder of the restricted document. The foregoing description of the system 100 in accordance with the present invention will better be understood when viewed in conjunction with the flowcharts illustrated in FIGS. 2, 3, and 4, described hereinafter.

Referring now to FIG. 2, there is shown a flowchart 200 illustrating the method in accordance with the present invention as viewed from the perspective of the document management server 104. Accordingly, the method begins at step 202 with the receipt of query data from a requesting client 120 by the document management server 104. The query data suitably includes, but is not limited to, one or more search criteria selected by an associated user to identify one or more documents stored in the document repository 106. The document management server 104 further receives identification data representative of the user associated with the requesting device 120 at step 204. In accordance with one aspect of the present invention, the identification data is used to authenticate the requesting user as having authorization to access the document management system. In another aspect of the instant invention, the received identification data is used to enable the document server 104 to prepare complete notification data to a custodian user 128 of a requested restricted document.

At step 206, the indexing engine 108 operatively coupled to the document management server 104 receives the query data and compares the query data to document index data corresponding to documents stored on the document repository 106. Those skilled in the art will appreciate that the indexing engine 108, upon receipt of new or modified documents from custodian user 128 via the custodian device 112, generates index data corresponding thereto. The index data is advantageously used to facilitate faster searching of the repository by the engine 108 upon receipt of a query request. The skilled artisan will appreciate that the indexing and searching of the repository 106 are accomplished via any suitable means known in the art. At step 208, a determination is made whether any documents meeting the submitted query parameters have been found by the indexing engine 108. When no documents have been located, flow proceeds to step 210, whereupon the indexing engine 108, via the server 104, generates and transmits a notification message to the requesting device 120 that no documents stored on the repository 106 meet the requested parameters, after which operations terminate with respect to the received search request.

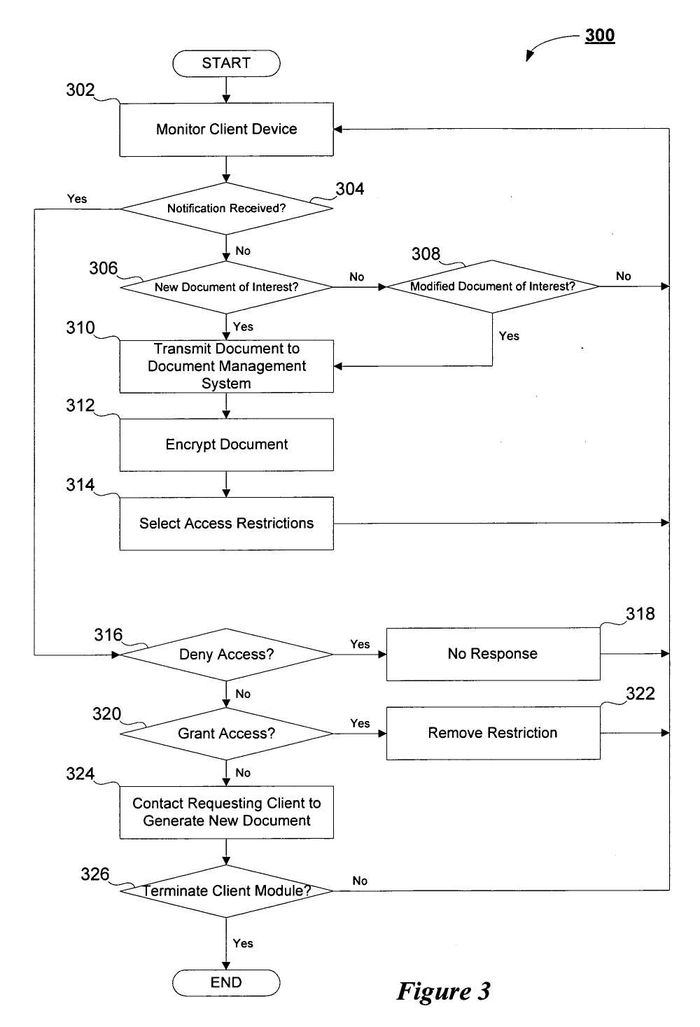

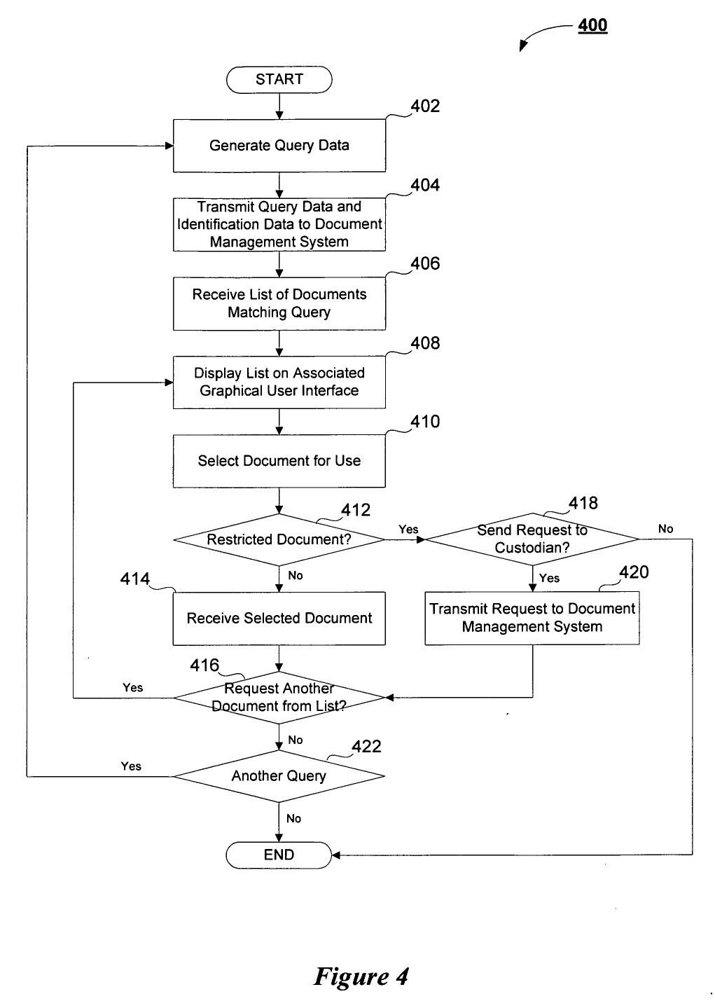

Returning to step 208, when one or more matching electronic documents have been located on the repository 106, flow proceeds to step 212, whereupon the indexing engine 108 generates a list of all documents found meeting the submitted query data. A determination is then made at step 214 whether any of the returned documents indicate a restricted level of access. When one or more documents restrict access, flow proceeds to step 216, whereupon the custodian 128 corresponding to each uncovered restricted access document is notified, via the custodian device 112, that a search result returned the restricted document. It is to be understood by those skilled in the art that the return of notification to the custodians of the restricted documents is an optional step illustrated in FIG. 2 for example purposes only and the preferred embodiment is not limited to requiring automatic notification for each search that returns a hit on a restricted access document. Irrespective of whether or not a restricted document is included in the generated list, the list is transmitted to the requesting client 120 at step 218 via any suitable means. Preferably, the document management server 104 transmits the list to the client module 122 of the requesting client device 120 via the computer network 102, whereupon the client module instructs the graphical user interface 124 to display the query results, i.e., the list, to the requesting user 130 for selection of one or more documents. Once the list has been returned to the requesting user 130 via the requesting client 120, flow proceeds to step 220, whereupon a document selection is received. A determination is then made at step 222 whether the selected document is a restricted document. When the document is not restricted, flow proceeds to step 224, wherein the indexing engine 108 retrieves the selected documents from the repository 106 and forwards the same to the requesting client 120. When the selected document is a restricted access document, flow proceeds to step 226, whereupon the requesting client 120 is notified as to the restricted nature of the selected document and prompts the client 120 for instructions as to proceed, following which flow returns to step 220. It will be understood by those skilled in the art that the instructions suitably correspond to requesting access to the document from the custodian user 128 via the document management server 104, as explained in greater detail below with respect to FIGS. 3 and 4.

Turning now to FIG. 3, there is shown a flowchart 300 illustrating method for maintaining documents by a custodian device in accordance -with the present invention. The skilled artisan will appreciate that the instant method is advantageously executed from the point of view of the custodian client device 112. Beginning at step 302, the client module 114 operating on the custodian device 112 monitors operations of the client device 112 via any suitable means. Preferably, the client module 114 monitors those applications on the custodian device 112 capable of modifying and/or generating electronic documents. More preferably, the client module 114 specifically monitors for the creation of new documents and the modification of existing documents of interest by the custodian user 128. A document of interest is an electronic document created or modified by the custodian user 128 having a document type/template meeting specified policy criteria for indexing and privacy settings. Suitable policy criteria includes, for example and without limitation, documents relating to a specific matter, originating in a specific application, documents addressed to a specific individual(s), and the like.

At step 304, a determination is made by the client module 114 whether a notification has been received regarding access to a restricted document of the custodian 128. When no such request is received, flow proceeds to step 306, whereupon a determination is made whether or not a new document of interest has been created. When a new document is detected, the determination is made by comparing the document against the policy criteria. When the no new document of interest has been detected, a determination is made at step 308 whether a document of interest has been modified. When it is determined that neither a new document of interest nor a modified document of interest has been detected, flow returns to step 302, wherein the client module 114 monitors for documents active on the custodian device 112. When either a new document of interest is determined at step 306, or when a modification has been made to a document of interest, as determined at step 308, flow proceeds to step 310, whereupon the document of interest is transmitted to the document management system. It will be understood by those skilled in the art that encryption of the document for transmission is capable of being employed prior to transmission at step 310, however for purposes of example only, encryption occurs following transmission and prior to storage in the document management repository 106.

Upon receipt of the document of interest, the document is encrypted at step 312 using any encryption means known in the art. The skilled artisan will appreciate that the encryption method employed is advantageously selected by a system administrator so as to prevent unauthorized access to documents stored in the repository 106. At step 314, access restrictions are selected for application to the document. It will be appreciated by those skilled in the art that the instant invention is capable of automatically applying access restriction based upon user or administrator preset conditions. In the preferred embodiment, the custodian user 128 selects the type and level of restrictions to be applied to the document. For example, the custodian user 128 is capable of restricting access to a certain group of users, restricting access from all users, allowing access to all users, and the like. The skilled artisan will appreciate that following step 314, the document is indexed by the indexing engine 108 and stored in document management repository 106 communicatively coupled to the server 104. Operations of the client module 114 return to the monitoring of the custodian device 112 at step 302.

When it is determined at step 304 that a notification has been received indicating that a user has requested access to a restricted document, flow then proceeds to step 316. In accordance with the present invention, notification included identification data representing the identity of the source of the access request. In one embodiment, the notification includes a rationale for the request. In another embodiment, the notification is in the form of an electronic message, sent by the requesting user 130 to the document management server 104 and forwarded to the custodian user 128. Preferably, the identity of the custodian user 128 is kept hidden from the requesting user 130 until such time as the custodian user 128 responds to the request or grants access to the document.

At step 316, a determination is made whether access to the requested document is to be denied. When the document request is denied, flow proceeds to step 318, whereupon the custodian user 128 does not respond to the request and operations return to monitoring of the system at step 302. When the request is not denied, flow proceeds to step 320, wherein a determination is made whether access is to be granted to the requesting user 130. When access has been granted, flow proceeds to step 322, whereupon the access restriction is removed and the requesting user 130 is allowed to retrieve the document from the repository 106. When access is not initially granted at step 320, flow progresses to step 324, whereupon the custodian 112 contacts the requesting user 130 for a determination of the information requested. The custodian user 128 is then able to generate a new document containing only the requested information and allow the requesting user 130 access to the new document. Alternatively, upon learning the information sought, the custodian user 128 is able to deny access to the information as so desired. Flow then proceeds to step 326 whereupon a determination is made whether the custodian user 128 has elected to terminate the client module 114. Operations end upon a positive determination and return to monitoring at step 302 following a negative determination.

Referring now to FIG. 4, there is shown a flowchart 400 illustrating a method for searching and requesting access to a document in accordance with the present invention. The skilled artisan will appreciate that the flowchart 400 is suitably applicable at the requesting client device 120, preferably initiated by an associated user 130 via the client module 122. Beginning at step 402, the client module 122 generates query data representative of one or more documents for which the associated user 130 desires access. The client module 122 then transmits, at step 404, the query data and user identification data to the document management server 104. At step 406, the client module 122 receives a list of documents meeting the query data request. The list of documents is then displayed via the graphical user interface 124 at step 408. At step 410, the associated user 130 selects a document from the list for which access is desired.

Following selection of a document by the requesting user 130, flow proceeds to step 412, whereupon a determination is made whether the selected document is a restricted access document. When the document is not a restricted access document, the selected document is retrieved by the indexing engine 108 from the repository 106 and received by the client module 122 at step 414. A determination is then made at step 416 whether the requesting user 130 desires to access another document from the list returned in response to the query data. When the user 130 desires to access another document, preferably indicated by user 130 selection of a back or return feature operable via the graphical user interface 124, flow returns to step 408, whereupon the list of matching documents is displayed. The requesting user 130 then selects a document at step 410 and a determination is made at step 412 whether the selected document is a restricted access document. When the selected document is a restricted access document, flow progresses to step 418, whereupon a determination is made whether the requesting user 130 desires to submit an access request to the custodian user 128. When no such request is forthcoming, operations accordingly terminate.

When the user does desire to submit an access request, flow proceeds to step 420, whereupon a request is transmitted to the document management server 104. Preferably, the request includes user identification data and document identification, e.g., index data, so as to enable the document server 104 to ascertain the custodian user 128 identity and forward the request thereon. Flow then returns to step 416, wherein a determination is made whether the requesting user 130 desires to access another document in the list returned in response to the query data. It will be appreciated by those skilled in the art that upon returning to the list at step 408, if the custodian user 128 has granted access, the requesting user 130 is able to select the non-restricted document thereon. However, if access is still denied, the list displays the restricted access document accordingly. Following a determination at step 416 that the user 130 does not desire to access another document from the returned list, flow proceeds to step 422. At step 422, a determination is made whether the user 130 desires to submit a new query to the document management system. When a new query is desired, flow returns to step 402 and operations of the client module 122 continue as explained above. When no new queries are desired, the operation in accordance with FIG. 4 terminates.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical, electromagnetic, or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for selective sharing of restricted electronic documents comprising:
means adapted for receiving query data representative of a query relative to a plurality of electronic documents stored in an associated memory, each of the electronic documents being associated with identifier data representative of at least one custodian thereof;
means adapted for receiving identification data corresponding to received query data, which identification data is representative of an identity of a source of a query associated therewith;
comparison means adapted for comparing the query data to document data associated with the plurality of electronic documents;
means adapted for generating list data representative of each document responsive to the query in accordance with an output of the comparison means, which list data includes data representative of at least one restricted document; and
notification means adapted for generating a notification signal to at least one custodian corresponding to each restricted document represented in the list data.

2. The system for selective sharing of restricted electronic documents of claim 1 further comprising means adapted for communicating the list data to the source of an associated query.

3. The system for selective sharing of restricted electronic documents of claim 2 further comprising:
means adapted for generating an access request from the source of the associated query for access to the at least one associated restricted document; and
means adapted for communicating the access request to each custodian associated with each restricted document.

4. The system for selective sharing of restricted electronic documents of claim 3 further comprising:
means adapted for receiving response data from the at least one custodian; and
means adapted for selectively releasing access to an associated restricted document in accordance with received response data.

5. The system for selective sharing of restricted electronic documents of claim 4 wherein the means adapted for selectively releasing access to the associated restricted document includes means adapted for selectively releasing access to only a portion of the associated restricted document.

6. The system for selective sharing of restricted electronic documents of claim 4 further comprising means adapted for generating a release notification signal to the source corresponding to the response data.

7. The system for selective sharing of restricted electronic documents of claim 4 further comprising means adapted for modifying access restriction data associated with the associated restricted access in accordance with received response data.

8. A method for selective sharing of restricted electronic documents comprising the steps of:
receiving query data representative of a query relative to a plurality of electronic documents stored in an associated memory, each of the electronic documents being associated with identifier data representative of at least one custodian thereof;
receiving identification data corresponding to received query data, which identification data is representative of an identity of a source of a query associated therewith;
comparing the query data to document data associated with the plurality of electronic documents;
generating list data representative of each document responsive to the query in accordance with an output of the comparison means, which list data includes data representative of at least one restricted document; and
generating a notification signal to at least one custodian corresponding to each restricted document represented in the list data.

9. The method for selective sharing of restricted electronic documents of claim 8 further comprising the step of communicating the list data to the source of an associated query.

10. The method for selective sharing of restricted electronic documents of claim 9 further comprising the steps of:
generating an access request from the source of the associated query for access to the at least one associated restricted document; and
communicating the access request to each custodian associated with each restricted document.

11. The method for selective sharing of restricted electronic documents of claim 10 further comprising the steps of:
receiving response data from the at least one custodian; and
selectively releasing access to an associated restricted document in accordance with received response data.

12. The method for selective sharing of restricted electronic documents of claim 11 wherein the step of selectively releasing access to the associated restricted document includes means adapted for selectively releasing access to only a portion of the associated restricted document.

13. The method for selective sharing of restricted electronic documents of claim 11 further comprising the step of generating a release notification signal to the source corresponding to the response data.

14. The method for selective sharing of restricted electronic documents of claim 11 further comprising the step of for modifying access restriction data associated with the associated restricted access in accordance with received response data.

15. A computer-implemented method for selective sharing of restricted electronic documents comprising the steps of:
receiving query data representative of a query relative to a plurality of electronic documents stored in an associated memory, each of the electronic documents being associated with identifier data representative of at least one custodian thereof;
receiving identification data corresponding to received query data, which identification data is representative of an identity of a source of a query associated therewith;
comparing the query data to document data associated with the plurality of electronic documents;
generating list data representative of each document responsive to the query in accordance with an output of the comparison means, which list data includes data representative of at least one restricted document; and
generating a notification signal to at least one custodian corresponding to each restricted document represented in the list data.

16. The computer-implemented method for selective sharing of restricted electronic documents of claim 15 further comprising the step of communicating the list data to the source of an associated query.

17. The computer-implemented method for selective sharing of restricted electronic documents of claim 16 further comprising the steps of:
generating an access request from the source of the associated query for access to the at least one associated restricted document; and
communicating the access request to each custodian associated with each restricted document.

18. The computer-implemented method for selective sharing of restricted electronic documents of claim 17 further comprising the steps of:
receiving response data from the at least one custodian; and
selectively releasing access to an associated restricted document in accordance with received response data.

19. The computer-implemented method for selective sharing of restricted electronic documents of claim 18 wherein the step of selectively releasing access to the associated restricted document includes means adapted for selectively releasing access to only a portion of the associated restricted document.

20. The computer-implemented method for selective sharing of restricted electronic documents of claim 18 further comprising the step of generating a release notification signal to the source corresponding to the response data.

21. The computer-implemented method for selective sharing of restricted electronic documents of claim 18 further comprising the step of for modifying access restriction data associated with the associated restricted access in accordance with received response data.
